(19) United States
(12) Patent Application Publication
(10) Pub. No.: US 2008/0058034 A1
(43) Pub. Date: Mar. 6, 2008

(54) HANDHELD ELECTRONIC DEVICE

(75) Inventors: Shih-Feng Lu, Taipei (TW); Yi-An Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/617,729

(22) Filed: Dec. 29, 2006

(30) Foreign Application Priority Data
Aug. 29, 2006 (CN) 200610112235.5

(51) Int. Cl. H04M 1/00

(52) U.S. Cl. 455/575.1

(57) ABSTRACT

A handheld electronic device which comprises a body, a sliding cover, and at least one sliding mechanism. The sliding cover is slidingly disposed on the body, and the sliding mechanism is disposed in the body. The sliding mechanism includes two fixed elements, a sliding block, and a slide. The sliding block is connected to the sliding cover. The slide used to connect the two fixed elements passes through the sliding block. The sliding block moves relatively to the slide. The sliding block is with permanent magnetism, and at least one of the fixed elements is with variable magnetism such that the sliding block is suitable for moving on the slide through the variation of magnetic force between the sliding block and the fixed elements to drive the sliding cover moving relatively to the body.

### CROSS-REFERENCE TO RELATED APPLICATION

This application claims the priority benefit of Chinese application serial no. 200610112235.5, filed Aug. 29, 2006. All disclosure of the Chinese application is incorporated herein by reference.

### BACKGROUND OF THE INVENTION

1. Field of the Invention

The invention relates to an electronic device, and more particularly, to a handheld electronic device.

2. Description of the Related Art

Because of their accessibility and portability, handheld electronic devices, such as mobile phones and personal digital assistants (PDA), have gradually become indispensable tools in our daily life. As for a mobile phone, a traditional leather sheath, a lifting cover housing, or even a sliding cover housing is provided for protecting the keyboard or the screen. Therefore, owing to the protection of the above-mentioned lifting cover or the sliding cover, dialing by mistake and damage due to external impact force can be avoided on a mobile phone.

Referring to FIG. 1, which is the three-dimensional schematic diagram of a known mobile phone. The mobile phone 100 includes a body 110 and a sliding cover 120. The body 110 has a screen 1 12, a keyboard 114 and a slide 116. The sliding cover 120 is slidingly disposed on the body 110 along the slide 116. When a user wants to open or close the sliding cover 120, he need apply force to drive sliding cover 120. However, just depending on a user applying force to the sliding cover 120, the sliding cover 120 often may not be opened or closed completely.

For amending above shortcomings, the idea of adding an elastic mechanism for driving sliding cover moving is brought forward. However the elastic mechanism may be with elastic fatigue after overused, which results in the poor movement of the sliding cover. Moreover, the size of an elastic mechanism is too large, and the noise of an elastic mechanism is too much during the moving of the sliding cover.

### BRIEF SUMMARY OF THE INVENTION

An objective of the invention provides a handheld electronic device, in which the sliding mechanism driving a sliding cover to open/close may be small and less noise, and without elastic fatigue.

To achieve above-mentioned objectives or other objectives, the invention provides a handheld electronic device, which includes a body, a sliding cover and least a sliding mechanism. The sliding cover is glidingly disposed on the body, and the sliding mechanism includes a fixed element, a sliding block, and a slide. The sliding block is connected to the sliding cover. The sliding block moves to drive the sliding cover moving relatively to the body. The slide is connected to the fixed element, and the fixed element and the slide are disposed in the body. The sliding block is passed through by the slide, and capable of moving relatively to the slide. Wherein variable magnetic force exists between the sliding block and the fixed element to alter force for the sliding block moving relatively to the fixed element, and then the sliding block may drive the sliding cover moving relatively to the body.

In an embodiment of the invention, the fixed element may have an induction coil inside.

In an embodiment of the invention, the fixed element may have an induction coil inside. Additionally, the induction coil may have two exposed transmission terminals.

In an embodiment of the invention, the sliding block is with permanent magnetism.

In an embodiment of the invention, the handheld electronic device further comprises a housing provided at the body. Wherein the housing has an opening, and the sliding mechanism is disposed in the housing, and then the sliding block and part of slide are exposed through the opening.

In an embodiment of the invention, the sliding block may have an induction coil inside.

In an embodiment of the invention, the sliding block may have an induction coil inside. Additionally, the induction coil may have two exposed transmission terminals.

In an embodiment of the invention, the fixed element is with permanent magnetism.

To achieve above-mentioned objectives or other objectives, the invention provides a handheld electronic device, which includes a body, a sliding cover and least a sliding mechanism. The sliding cover is glidingly disposed on the body, and the sliding mechanism includes two fixed elements, a sliding block, and a slide. The sliding block is connected to the sliding cover. The sliding block moves to drive the sliding cover moving relatively to the body. The slide is connected to two fixed elements, and the fixed element and the slide are disposed in the body. The sliding block may be passed through by the slide, and move relatively to the slide. Wherein variable magnetic force exists between the sliding block and at least one of the fixed elements to alter force for the sliding block moving relatively to the fixed element, and then the sliding block may drive the sliding cover moving relatively to the body.

In an embodiment of the invention, the sliding block may have an induction coil inside.

In an embodiment of the invention, the sliding block may have an induction coil inside. Additionally, the induction coil may have two exposed transmission terminals.

In an embodiment of the invention, the fixed element is with permanent magnetism.

In an embodiment of the invention, the handheld electronic device further comprises a housing provided at the body. Wherein the housing has an opening, and the sliding mechanism is disposed in the housing, and then the sliding block and part of slide are exposed through the opening.

In an embodiment of the invention, the fixed element may have an induction coil inside.

In an embodiment of the invention, the fixed element may have an induction coil inside. Additionally, the induction coil may have two exposed transmission terminals.

In an embodiment of the invention, the sliding block is with permanent magnetism.

As described above, the sliding cover of the handheld electronic device according to the invention is opened and closed through the variation of magnetic force between the sliding block and the fixed elements, and therefore compared with a known elastic mechanism, there is no problem of elastic fatigue happened to the handheld electronic device according to the invention, and the sliding mechanism of the handheld electronic device according to the invention occupies less space and is less noise during the sliding cover moving.

These and other features, aspects, and advantages of the present invention will become better understood with regard to the following description, appended claims, and accompanying drawings.

### BRIEF DESCRIPTION OF THE DRAWINGS

FIG. 1 is a three-dimensional schematic diagram showing a known mobile phone.

FIG. 2 is a schematic diagram showing the top view of a handheld electronic device according to the first embodiment of the invention.

FIG. 3 is a schematic diagram showing the side view of the handheld electronic device of FIG. 2.

FIG. 4 is a three-dimensional schematic diagram showing the sliding mechanism of the handheld electronic device shown in FIG. 2 and FIG. 3.

FIG. 5 is a schematic diagram showing the closing process of the sliding cover of the handheld electronic device shown in FIG. 3.

FIG. 6 is a schematic diagram showing the top view of a handheld electronic device according to the second embodiment of the invention.

FIG. 7 is a schematic diagram showing the side view of the handheld electronic device of FIG. 6.

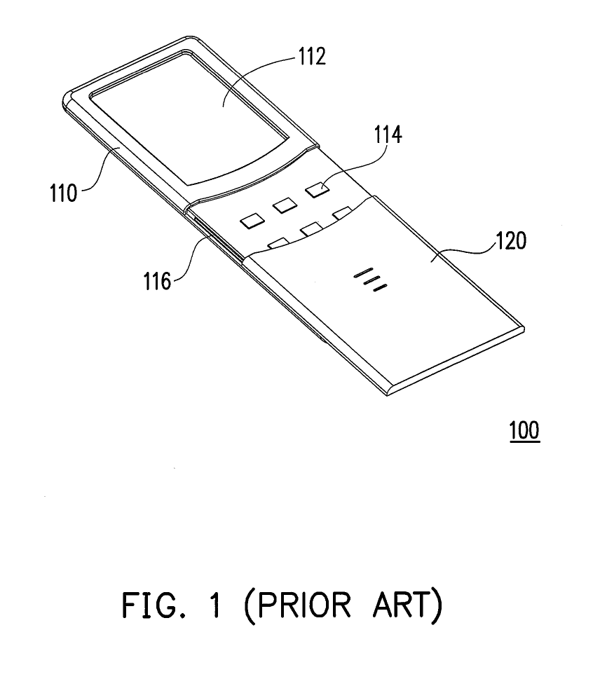

### DETAILED DESCRIPTION OF THE EMBODIMENTS

### The First Embodiment

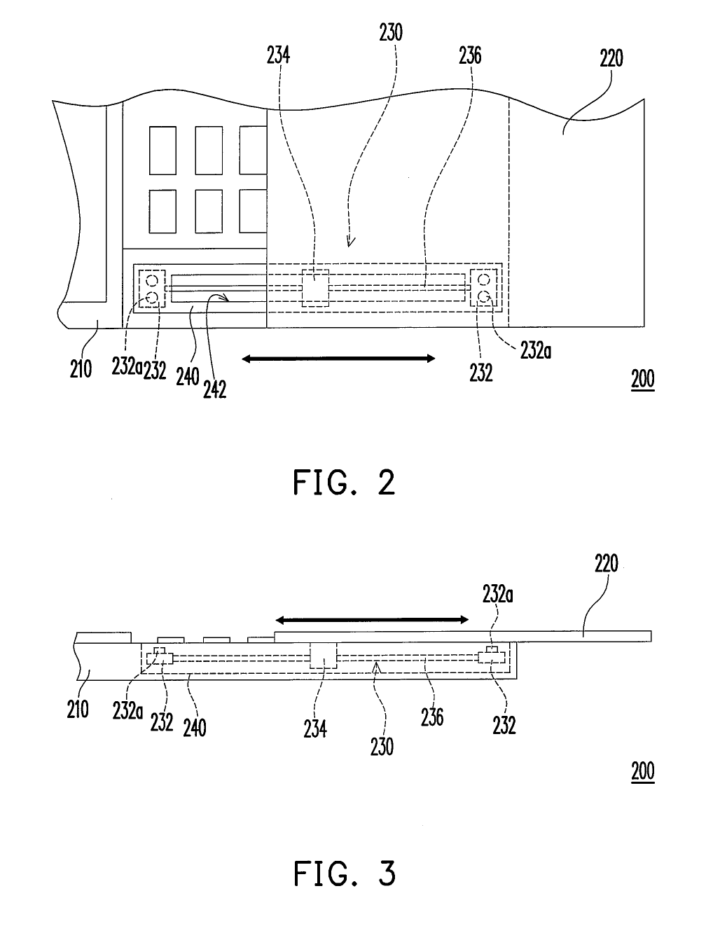

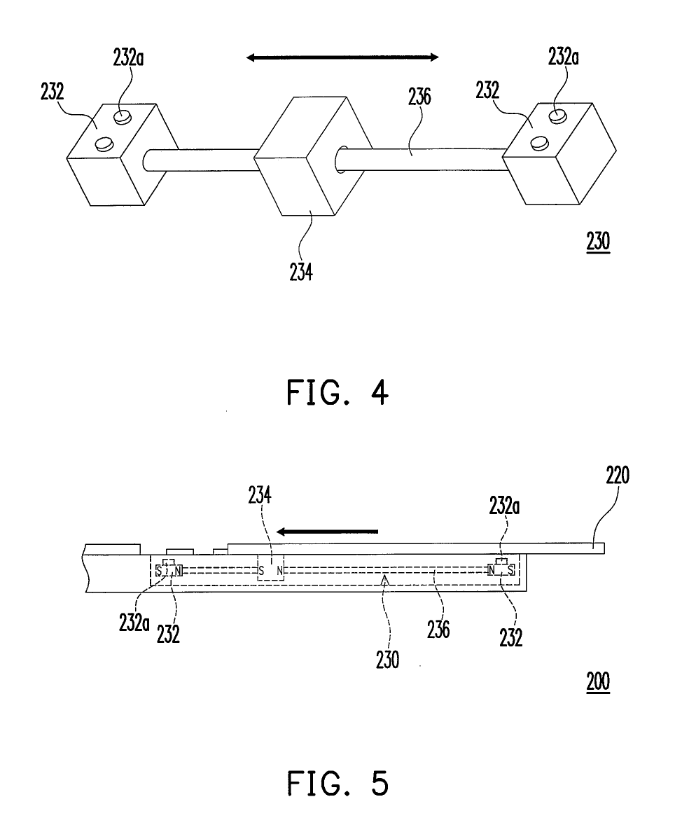

FIG. 2 is a schematic diagram showing the top view of a handheld electronic device according to the first embodiment of the invention. FIG. 3 is a schematic diagram showing the side view of the handheld electronic device of FIG. 2. FIG. 4 is a three-dimensional schematic diagram showing the sliding mechanism of the handheld electronic device shown in FIG. 2 and FIG. 3. Referring to FIG. 2, FIG. 3 and FIG. 4, the handheld electronic device 200 according to the embodiment includes a body 210, a sliding cover 220, and at least a sliding mechanism 230. However, for simplifying the drawings, only one sliding mechanism is shown in FIG. 2 and FIG. 3 for illustration purpose. The sliding cover 220 is slidingly disposed on the body 210, and the sliding mechanism 230 is disposed in the body 210. The sliding mechanism 230 includes two fixed elements 232, a sliding block 234, and a slide 236. The sliding block 234 is connected to the sliding cover 220, and the slide 236 is used to connect the two fixed elements 232. Moreover, the slide 236 passes through the sliding block 234, and the sliding block 234 may move relatively to the slide 236.

The sliding block 234, which may be a permanent magnet, is with permanent magnetism, and at least one of the fixed elements 232 is with variable magnetism (taking the fixed elements 232 with variable magnetism as an example herein), which may be an electromagnet. Therefore, the sliding block 234 is suitable for moving on the slide 236 through the variation of magnetic force between the sliding block 234 and the fixed elements 232 to drive the sliding cover 220 moving relatively to the body 210. It's worth noting that, the sliding cover 220 is opened and closed through the variation of magnetic force between the sliding block 234 with permanent magnetism and the fixed elements 232 with variable magnetism, and therefore there is no problem of elastic fatigue happened to a known elastic mechanism.

In the embodiment, the handheld electronic device 200 further includes a housing 240 provided at the body 210. The housing 240 has an opening 242, and the sliding mechanism 230 is disposed in the housing 240 while the sliding block 234 and part of the slide 236 are exposed through the opening 242. In addition, the sliding mechanism 230 may be preinstalled in the housing 240, and then the housing 240 and the sliding mechanism 230 are disposed in the body 210, or the housing 240 may be provided at the body 210 in advance, and then the sliding mechanism 230 is disposed in the housing 240. One may choose one of the assemble sequence mentioned above according to the size of the opening and the shape of the housing; the invention has no limitation about this. Furthermore, the housing 240 may be used to avoid foreign bodies going into the sliding range of the sliding block 234 and then damaging the sliding mechanism 230, when the sliding cover 220 moves to the open position.

The configuration of the fixed element 232 and the operation of the sliding mechanism 230 will be described hereinbelow. FIG. 5 is the schematic diagram showing the closing process of the sliding cover of the handheld electronic device shown in FIG. 3. Referring to FIGS. 2, 3, 4 and 5, in the embodiment, the fixed elements 232 may have induction coils inside (not shown in drawings), and each of the induction coils may have two exposed transmission terminals 232a. When the ends of the two fixed elements 232 opposite the sliding block 234 is with the same magnetic polarity owing to electric current flowing in the induction coil of each fixed element 232 through one of the transmission terminals 232a (that is the inner magnetic field directions of the two fixed elements 232 with magnetism are opposite), the sliding block 234 may move to one of the fixed elements 232 and from the other one. Therefore, the sliding cover 220 may be opened and closed owing to attracting or repelling the sliding block 234 through the magnetism variation of the two fixed elements 232. Referring to FIG. 5, if the magnetic field between the sliding elements 234 with magnetism and the two fixed elements 232 with magnetism is shown as FIG. 5, the S pole of the sliding block 234 is attracted by the N pole of the fixed element 232 in the left of FIG. 5, and the N pole of the sliding block 234 is repelled by the N pole of the fixed element 232 in the right of FIG. 5. Therefore, the sliding cover 220 is in the process of closing. If only one of the fixed elements 232 is with variable magnetism, the sliding block 234 may drive the sliding cover 220 to open or close, which depends on the designer's demand.

### The Second Embodiment

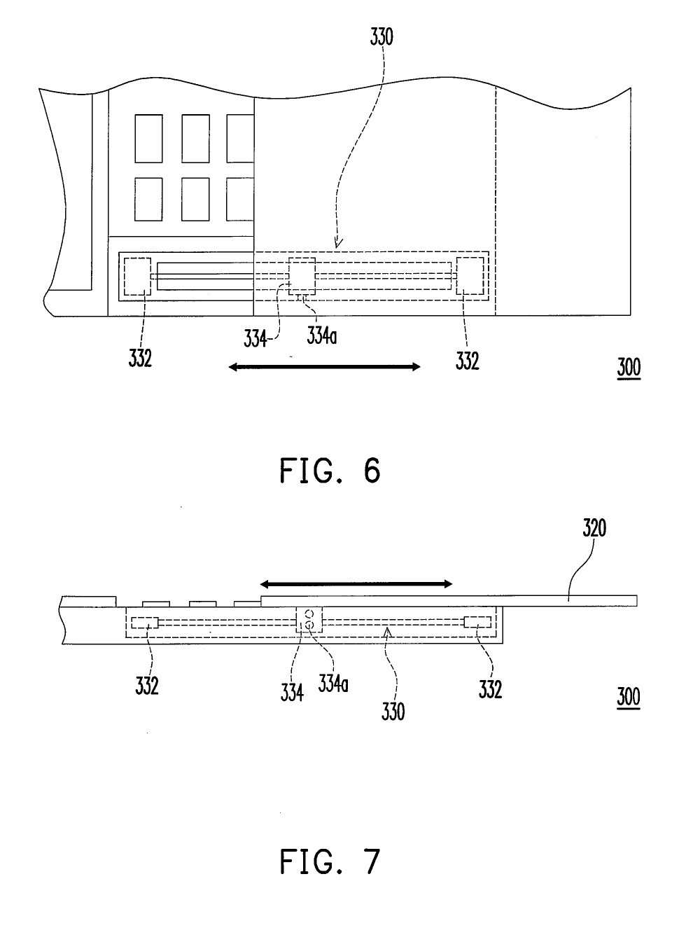

FIG. 6 is a schematic diagram showing the top view of a handheld electronic device according to the second embodiment of the invention, and FIG. 7 is a schematic diagram showing the side view of the handheld electronic device of FIG. 6. Referring to FIG. 6 and FIG. 7, it is mostly different between the handheld electronic device 200 according to the first embodiment and the one 300 according to the second embodiment that the sliding block 334 of the sliding mechanism 330 is with variable magnetism, and at least one of the fixed elements 332 is with permanent magnetism (taking the two fixed elements 332 with permanent magnetism as an example herein).

The inner magnetic field directions of the two fixed elements 232 with permanent magnetism are opposite. Therefore, when the induction coil (not shown in drawings) inside the sliding block 334 is with induced magnetism owing to electric current flowing in the induction coil through one of the transmission terminals 334a, the sliding block 334 may move to one of the fixed elements 332 and from the other. Therefore, the sliding cover 320 may be opened and closed owing to attracted or repelled by the fixed elements 332 through the magnetism variation of the sliding block 334. It's worth noting that, if only one of the fixed elements 332 is with permanent magnetism, the sliding block 334 may drive the sliding cover 320 to open or close, which depends on the designer's demand.

As described above, the handheld electronic device according to the invention has at least the following advantages:

1. The sliding cover of the handheld electronic device according to the invention is opened and closed through the variation of magnetic force between the sliding block and the fixed elements, and therefore compared with a known elastic mechanism, there is no problem of elastic fatigue happened to the handheld electronic device according to the invention.

2. The sliding cover of the handheld electronic device according to the invention is opened and closed through the variation of magnetic force between the sliding block and the fixed elements, and therefore compared with a known elastic mechanism, the sliding mechanism of the handheld electronic device according to the invention occupies less space and is less noise during moving of the sliding cover.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A handheld electronic device, comprising:
a body;
a sliding cover slidingly disposed on said body; and
at least a sliding mechanism comprising:
a fixed element provided in said body;
a sliding block being connected with said sliding cover, said sliding block moving to drive said sliding cover moving relatively to said body; and
a slide being connected with said fixed element and passing through said sliding block resulting in said sliding block being capable of moving relatively to said slide, wherein variable magnetic force exists between said sliding block and said fixed element to alter force for said sliding block moving relatively to said fixed element.

2. The handheld electronic device according to claim 1, wherein said fixed element has an induction coil.

3. The handheld electronic device according to claim 2, wherein said induction coil has two exposed transmission terminals.

4. The handheld electronic device according to claim 2, wherein said sliding block is with permanent magnetism.

5. The handheld electronic device according to claim 1, further comprising a housing provided at said body, wherein said housing has an opening, and said sliding mechanism is disposed in said housing, and then said sliding block and part of slide are exposed through said opening.

6. The handheld electronic device according to claim 1, wherein said fixed element is with permanent magnetism.

7. The handheld electronic device according to claim 6, wherein said sliding block has an induction coil inside.

8. The handheld electronic device according to claim 7, wherein said induction coil has two exposed transmission terminals.

9. A handheld electronic device, comprising:
a body;
a sliding cover slidingly disposed on said body; and
at least a sliding mechanism comprising:
two fixed elements provided in said body;
a sliding block being connected with said sliding cover, said sliding block moving to drive said sliding cover moving relatively to said body; and
a slide being connected with said fixed elements and passing through said sliding block resulting in said sliding block being capable of moving relatively to said slide, wherein variable magnetic force exists between said sliding block and at least one of said fixed elements to alter force for said sliding block moving relatively to said fixed element.

10. The handheld electronic device according to claim 9, wherein said fixed element has an induction coil.

11. The handheld electronic device according to claim 10, wherein said fixed element has two exposed transmission terminals.

12. The handheld electronic device according to claim 10, wherein said sliding block is with permanent magnetism.

13. The handheld electronic device according to claim 9, further comprising a housing provided at said body, wherein said housing has an opening, and said sliding mechanism is disposed in said housing, and then said sliding block and part of slide are exposed through said opening.

14. The handheld electronic device according to claim 9, wherein at least one of said fixed elements is with permanent magnetism.

15. The handheld electronic device according to claim 14, wherein said sliding block has an induction coil inside.

16. The handheld electronic device according to claim 15, wherein said induction coil has two exposed transmission terminals.
